(19) United States
(12) Patent Application Publication
(10) Pub. No.: US 2005/0002369 A1
(43) Pub. Date: Jan. 6, 2005

(54) Apparatus and method for cell search in mobile communication system using a multiple access scheme

(75) Inventors: Jung-Min Ro, Seoul (KR); Young-Kwon Cho, Suwon-si (KR); Hyeon-Woo Lee, Suwon-si (KR); Dong-Seek Park, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/885,112

(22) Filed: Jul. 6, 2004

(30) Foreign Application Priority Data
Jul. 4, 2003 (KR) 45301-2003

(51) Int. Cl. H04B 7/216

(52) U.S. Cl. 370/342; 370/208

(57) ABSTRACT

An apparatus and a method for cell search in an orthogonal frequency division multiplexing-based mobile communication system using a multiple access scheme. The method includes the steps of: detecting a symbol boundary of an input reception signal; detecting a frame cell boundary after synchronizing with the detected symbol boundary; detecting a reference signal for each symbol interval in a preset search interval; and detecting a pattern of the detected reference signals and detecting a base station to which the terminal belongs.

PRIORITY

This application claims priority to an application entitled “Apparatus And Method For Cell Search In Mobile Communication System Using A Multiple Access Scheme” filed in the Korean Intellectual Property Office on Jul. 4, 2003 and assigned Ser. No. 2003-45301, the contents of which are incorporated herein by reference.

### BACKGROUND OF THE INVENTION

1. Field of the Invention

The present invention relates to a mobile communication system using a multiple access scheme, and more particularly to an apparatus and a method for conducting a cell search in an orthogonal frequency division multiplexing (OFDM)-based mobile communication system using a multiple access scheme.

2. Description of the Related Art

Recently, researches into the next generation mobile communication systems for transmitting high speed data in mobile communication systems have been actively pursued. The next generation mobile communication systems have been standardized with the aim of providing efficient interworking and integration of services between a wired communication network and a wireless communication network, in addition to simple wireless communication services provided by previous generations of mobile communication systems. Accordingly, the development of the technology capable of transmitting high capacity data similar to that of the data capacity of a wired communication network has been required in a wireless communication network.

For this reason, an orthogonal frequency division multiplexing (hereinafter, referred to as an OFDM) method has been actively studied as a method useful for high speed data transmission in a wired/wireless channel for the next generation mobile communication systems. The OFDM method is a method by which data is transmitted through a multi-carrier. That is, the OFDM method is a kind of multi-carrier modulation (MCM) method by which a symbol row input as serial data is converted to a parallel symbol, each converted symbol row is modulated into a plurality of sub-carriers having a mutual orthogonality (i.e., a plurality of sub-carrier channels), and the sub-carrier channels are transmitted.

In order to provide high speed and high quality wireless multimedia services targeted by the next generation mobile communication systems, wideband spectrum resources are required. However, when the wideband spectrum resources are used, a fading influence on a wireless transmission line becomes serious due to the multi-path propagation, and the influence due to a frequency selective fading occurs even in a transmission band. Accordingly, for a high speed wireless multimedia service, the OFDM method, which is resistant against frequency selective fading, has a gain greater than that of a code division multiple access (hereinafter, referred to as a CDMA) method. For this reason, recently, researches into an OFDM method have been actively pursued.

Generally, in the OFDM method, since spectrums between sub-carriers, that is sub-carrier channels, maintain a mutual orthogonality and are overlapped from each other, spectrum efficiency is good. Further, in the OFDM method, modulation is achieved by an inverse fast Fourier transform (hereinafter, referred to as an IFFT) and demodulation is achieved by a fast Fourier transform (hereinafter, referred to as an FFT). A multiple access scheme based on the OFDM method as described above includes an orthogonal frequency division multiple access (hereinafter, referred to as an OFDMA) method, which allows some of the sub-carriers to be assigned to a predetermined terminal and the assigned sub-carriers to be used. The OFDMA method does not require a spreading sequence for band spreading and can dynamically change a set of sub-carriers, which are assigned to a predetermined terminal, according to a fading characteristic of a wireless transmission line. Herein, the dynamic changing of a set of sub-carriers assigned to a predetermined terminal is called a dynamic resource allocation method, and the dynamic resource allocation method includes a frequency hopping (FH) method, etc.

Consequently, the next generation mobile communication systems have been developed while taking into consideration both a software standpoint in which various contents are to be developed and a hardware standpoint in which a wireless connection method having a high spectrum efficiency is to be developed to provide the best quality of service (QoS). Hereinafter, from among the aforementioned two standpoints, the hardware standpoint considered by the next generation mobile communication systems will be described.

In a wireless communication, factors preventing a high speed and high quality data service are generally caused by the channel environments. The channel environments in the wireless communication are frequently changed by power fluctuation of a received signal occurring by a fading, a shadowing, a Doppler effect according to movement and frequent speed change of a terminal, and interference due to other users and a multi-path signal, in addition to additive white Gaussian noise (AWGN). Accordingly, in order to provide a high speed wireless data packet service, another developed technology capable of adaptively coping with the change of channel environments has been required, in addition to technologies provided by the existing 2^{nd} generation or 3^{rd} generation mobile communication systems. Herein, a high speed power control method employed in the existing systems can adaptively cope with the change of channel environments. However, an adaptive modulation and coding (hereinafter, referred to as an AMC) method and a hybrid automatic retransmission request (hereinafter, referred to as a HARQ) method are commonly proposed by both the 3^{rd} generation partnership project (hereinafter, referred to as a 3GPP) and the 3^{rd} generation partnership project 2 (hereinafter, referred to as a 3GPP2) which standardize the high speed data packet transmission systems. Herein, the 3GPP is the standardization organization employing an asynchronous method and the 3GPP2 is the standardization organization employing a synchronous method.

When the AMC method and the HARQ method are used, the entire performance of a system is greatly improved. However, even though the AMC method and the HARQ method are used, the shortage of radio resources, a basic problem in a wireless communication system, is not resolved. That is, in order to maximize a subscriber capacity and perform high speed data transmission necessary for a multimedia service, it is important to develop a multiple access scheme having excellent spectrum efficiency. Accordingly, in order to provide a high speed and high quality packet data service, the necessity for a new multiple access scheme having an excellent spectrum efficiency has emerged. Also, the necessity for a method for efficient cell search in a new multiple access scheme has also emerged, which is suitable for a high speed and high quality packet data service and has an excellent spectrum efficiency.

### SUMMARY OF THE INVENTION

Accordingly, the present invention has been made to solve the above mentioned and another problems occurring in the prior art, and an object of the present invention is to provide an apparatus and a method for conducting a cell search in a mobile communication system providing a high speed wireless multimedia service.

Another object of the present invention is to provide an apparatus and a method for conducting a multi-step cell search in a mobile communication system providing a high speed wireless multimedia service.

In order to accomplish the aforementioned objects, according to one aspect of the present, there is provided an apparatus for searching for a cell in a mobile communication system employing a multiple access scheme, the apparatus including: a symbol synchronization acquisition unit for detecting a symbol boundary of an input reception signal; a frame cell synchronization acquisition unit for detecting a frame cell boundary after synchronizing with the symbol boundary detected by the symbol synchronization acquisition unit; a pattern detector for detecting a reference signal for each symbol interval in a preset search interval, and detecting a pattern of the detected reference signals; and a controller for comparing the pattern detected by the pattern detector with stored patterns and detecting a base station to which the terminal belongs.

In order to accomplish the aforementioned objects, according to one aspect of the present, there is provided an apparatus for searching for a cell in a mobile communication system employing a multiple access scheme, the apparatus including: a symbol synchronization acquisition unit for detecting a symbol boundary of an input reception signal; a pattern detector for detecting a reference signal for each symbol interval in a preset search interval after synchronizing with the symbol boundary detected by the symbol synchronization acquisition unit, and detecting a pattern of the detected reference signals; and a controller for comparing the pattern detected by the pattern detector with patterns stored in advance and detecting a base station to which the terminal belongs.

In order to accomplish the aforementioned objects, according to one aspect of the present, there is provided a method for searching for a cell by a terminal in a mobile communication system employing a multiple access scheme, the method including the steps of: a) detecting a symbol boundary of an input reception signal; b) detecting a frame cell boundary after synchronizing with the detected symbol boundary; c) detecting a reference signal for each symbol interval in a preset search interval; and d) detecting a pattern of the reference signals and determining a base station to which the terminal belongs.

In order to accomplish the aforementioned objects, according to one aspect of the present, there is provided a method for searching for a cell by a terminal in a mobile communication system employing a multiple access scheme, the method including the steps of: a) detecting a symbol boundary of an input reception signal; b) detecting a reference signal for each symbol interval in a preset search interval after synchronizing with the symbol boundary; and c) detecting a pattern of the reference signal and determining a base station to which the terminal belongs.

### BRIEF DESCRIPTION OF THE DRAWINGS

The above and other objects, features and advantages of the present invention will be more apparent from the following detailed description taken in conjunction with the accompanying drawings, in which:

FIG. 1 is a graph showing a time-frequency resource allocation in a communication system using an FH-OFCDMA method according to the present invention;

FIG. 2 is a block diagram showing a structure of a forward channel of an FH-OFCDMA communication system according to the present invention;

FIG. 3 is a block diagram showing a structure of a channel transmitter in an FH-OFCDMA communication system for performing functions according to an embodiment of the present invention;

FIG. 4 is a block diagram showing a structure of a transmitter in an FH-OFCDMA communication system for performing functions according to an embodiment of the present invention;

FIG. 5 is a block diagram showing the structure of the receiver in an FH-OFCDMA communication system for performing functions according to an embodiment of the present invention;

FIG. 6 is a block diagram showing an internal structure of a cell search apparatus in an FH-OFCDMA communication system for performing functions according to an embodiment of the present invention;

FIG. 7 is a flowchart of a first cell search process in an FH-OFCDMA communication system according to an embodiment of the present invention; and

FIG. 8 is a flowchart of a second cell search process in an FH-OFCDMA communication system according to an embodiment of the present invention.

### DETAILED DESCRIPTION OF THE PREFERRED EMBODIMENT

Hereinafter, a preferred embodiment according to the present invention will be described with reference to the accompanying drawings. In the following description of the present invention, a detailed description of known functions and configurations incorporated herein will be omitted for conciseness.

Firstly, in the present invention, a multiple access scheme according to efficient time-frequency resource use for a high speed and high quality wireless multimedia service targeted by a next generation mobile communication system will be described.

Generally, an OFDMA method does not require a spreading sequence for band spreading and can dynamically change a set of sub-carriers, which are assigned to a predetermined terminal, according to a fading characteristic of a wireless transmission line. Herein, dynamically changing a set of sub-carriers assigned to a predetermined terminal is called a dynamic resource allocation method, and the dynamic resource allocation method includes a frequency hopping method, or other known resource allocation methods.

In contrast, a multiple access scheme requiring a spreading sequence may be classified into a spreading method in a time domain and a spreading method in a frequency domain. In the spreading method in the time domain, a terminal signal, that is a user signal, is band-spread in the time domain and then the band-spread signal is mapped to a sub-carrier. In the spreading method in the frequency domain, a user signal is demultiplexed in a time domain to be mapped to a sub-carrier, and the user signal is differentiated in the frequency domain by means of an orthogonal sequence.

The multiple access scheme that is proposed by the present invention and will be described later has not only characteristics of a multiple access method based on the OFDMA method but also characteristics resistant against a frequency selective fading through the characteristics of a CDMA method and a frequency hopping method. In the present invention, the multiple access scheme newly proposed as described above is called a frequency hopping-orthogonal frequency code division multiple access (hereinafter, referred to as an FH-OFCDMA) method.

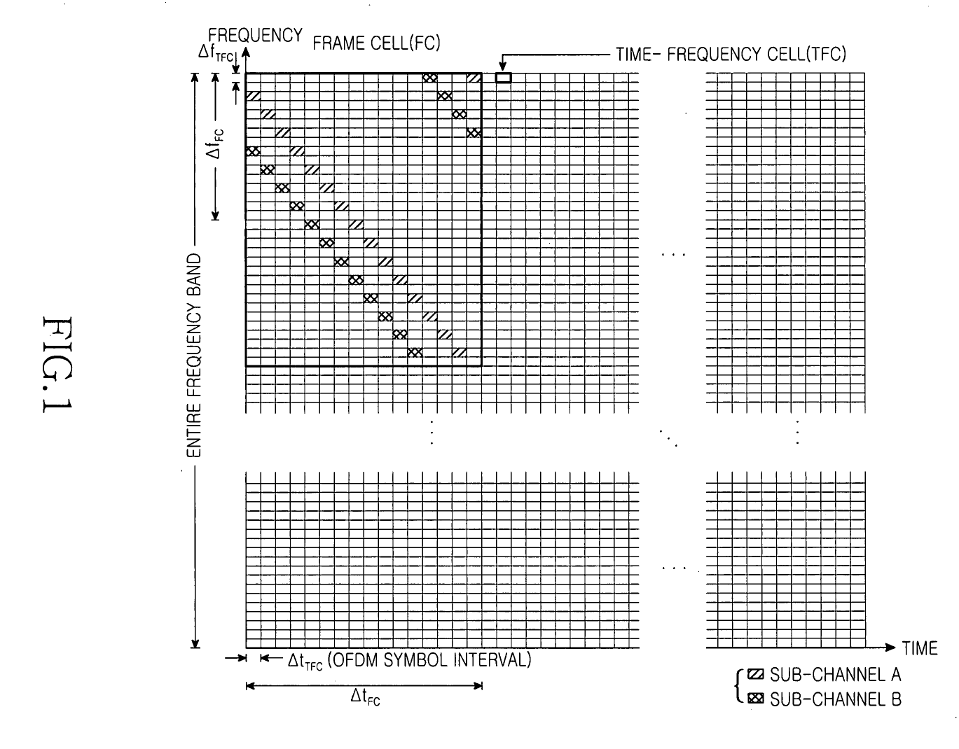

The FH-OFCDMA method proposed by the present invention will be described with reference to FIG. 1.

FIG. 1 is a graph showing a time-frequency resource allocation in a communication system using the FH-OFCDMA method according to the present invention. Referring to FIG. 1, a unit quadrangle shown in FIG. 1 is constructed by a predetermined number of sub-carriers and is defined as a time-frequency cell (TFC) having the same frame duration as that of an OFDM symbol interval. Further, a plurality of sub-carriers are assigned to the time-frequency cell. In the present invention, data corresponding to each sub-carrier assigned to the time-frequency cell are processed by a CDMA method and are then processed by an OFDM method using each sub-carrier. Herein, the processing by the CDMA method includes spreading data by a specific channelization code set in advance according to each sub-carrier and scrambling the spread data by a preset scrambling code. A frame cell (FC) in FIG. 1 includes a bandwidth AfFc corresponding to a predetermined multiple (e.g., 32 times) of the time-frequency cell and a time-frequency domain having a frame duration corresponding to a predetermined multiple (e.g., 16 times) of the time-frequency cell. In the present invention, using the frame cell prevents the measurement results for a radio transmission from being frequently reported when an adaptive modulation and coding (AMC) method is employed.

In FIG. 1, a sub-channel A and a sub-channel B, which are two sub-channels different from each other, are contained in one frame cell. Herein, the sub-channel represents a channel in which a predetermined number of time-frequency cells set in advance are frequency-hopped according to a predetermined frequency hopping pattern set in advance on the basis of the passage of time and then transmitted. The number of time-frequency cells including the sub-channel and the frequency hopping pattern can be variably set according to the conditions of a system. In the present invention, for convenience of description, it is assumed that 16 time-frequency cells constitute one sub-channel. Each of the two sub-channels different from each other may be assigned to terminals different from each other or to one terminal. Each sub-channel is hopped by a predetermined frequency interval according to the passage of time. This shows that a sub-channel assigned to each terminal is dynamically changed by a fading characteristic that changes over time. Further, the frequency hopping pattern is shown as a certain fixed pattern in FIG. 1, but the scope of the present invention is not limited by the fixed pattern. That is, the frequency hopping pattern according to the present invention can be variably set.

When the adaptive modulation and coding method is employed, the terminal measures the state of a wireless transmission line within a predetermined period and notifies a base station of the measurement result. In response to the notification, the base station adjusts a modulation method and a coding method according to the information related to the state of the wireless transmission line notified by the terminal, and notifies the terminal of the adjusted modulation method and coding method. Then, the terminal transmits a signal according to the modulation method and the coding method adjusted by the base station. In the present invention, the information related to the state of the wireless transmission line is reported in a unit of a frame cell, thereby reducing a signaling load occurring by employing the adaptive modulation and coding method. Meanwhile, the frame cell can be adaptively adjusted according to the amount of overhead information accompanied by an application of the adaptive modulation and coding method. For instance, when the amount of overhead information is great, the frame cell is widely adjusted. In contrast, when the amount of overhead information is small, the frame cell is narrowly adjusted.

Meanwhile, in order to provide a service with respect to a predetermined terminal according to an embodiment of the present invention, a transmitter can in principle use a plurality of sub-channels. In order to use such multiple sub-channels, requirement conditions of quality of service (QoS) and the number of terminals simultaneously using the service must be considered.

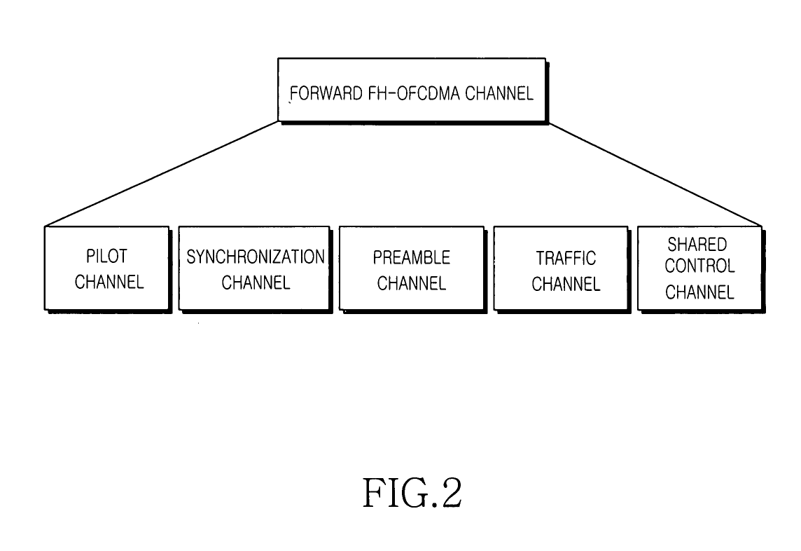

Hereinafter, forward channels of a communication system using the FH-OFCDMA method (hereinafter, referred to as an FH-OFCDMA communication system) will be described with reference to FIG. 2.

FIG. 2 is a block diagram showing a structure of the forward channel of the FH-OFCDMA communication system according to the present invention. In FIG. 2, a forward channel for a communication system employing the FH-OFCDMA, which is a multiple access scheme proposed by the present invention, is defined as a forward FH-OFCDMA channel. The forward FH-OFCDMA channel may include a pilot channel, a sync channel, a traffic channel, and a shared control channel, or may consist of only a preamble channel. Since a structure of the forward FH-OFCDMA channel will be described later, a detailed description of the forward FH-OFCDMA channel will be omitted. The pilot channel is used when a terminal acquires a base station or performs a channel estimation, and the sync channel is used when a terminal acquires information and timing information on a base station. The preamble channel is basically used for a frame synchronization and may be used for a channel estimation during a communication. The traffic channel is used as a physical channel for transmitting information data. FIG. 2 shows a structure containing the preamble channel for frame synchronization, but a preamble sequence transmitted through the preamble channel may also be transmitted as a preamble sequence of a frame transmitted through the traffic channel. The shared control channel is used as a physical channel for transmitting control information, which is required by a receiver in order to receive the information data transmitted through the traffic channel.

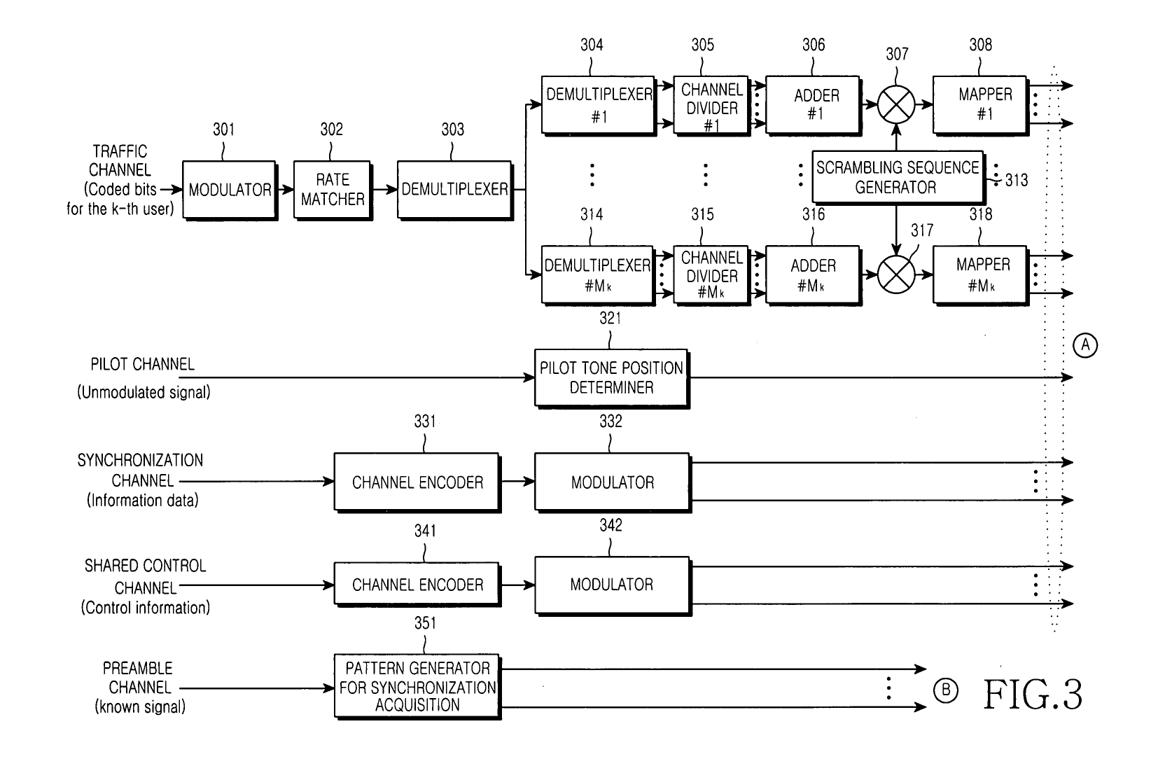

FIG. 3 is a block diagram showing the structure of the channel transmitter in the FH-OFCDMA communication system for performing functions according to an embodiment of the present invention. FIG. 3 shows transmitters according to each channel shown in FIG. 2. However, before describing the structure of a channel transmitter, it must be noted that the structure of the channel transmitter shown in FIG. 3 is a structure suitable for use when the FH-OFCDMA communication system uses the forward channels as described in FIG. 2. That is, when the forward channels used in the FH-OFCDMA communication system are different from each other, the structure of the channel transmitter may change according to the forward channels.

Hereinafter, the structure of the channel transmitter shown in FIG. 3 will be described according to each forward channel transmitter.

First, a traffic channel transmitter will be described, which transmits information data, that is, user data, through the traffic channel.

First of all, a row of coded bits, targeting an k^{th} terminal having experienced a channel coding process, etc., is input to a modulator 301. The modulator 301 modulates the coded bits by means of a predetermined modulation method, such as a quadrature phase shift keying (QPSK) method, a 16 quadrature amplitude modulation (QAM) method, or 64 quadrature amplitude modulation method, according to the state of a wireless transmission line. Then, the modulator 301 outputs the modulated symbols to a rate matcher 302. Herein, when the FH-OFCDMA communication system uses an adaptive modulation and coding method, a modulation method used by the modulator 301 is variably set according to the control of a controller.

The rate matcher 302 inputs the modulated symbols output from the modulator 301, rate-matches the input modulated symbols according to an actual physical channel, that is, the traffic channel, and outputs the rate-matched symbols to a demultiplexer (demux) 303. Herein, the rate matcher 302 rate-matches the modulated symbols through repetition or puncturing. That is, the rate matcher 302 processes and outputs the modulated symbols according to the transmission format of a packet transmitted through a radio channel. The transmission format includes the number of modulated symbols, which can be transmitted through one frame. The demultiplexer 303 inputs a row of the modulated symbols output from the rate matcher 302, demultiplexes the input row of the modulated symbols into modulation symbol rows, which correspond to the number of predetermined branches, according to each sub-channel, and outputs the modulation symbol rows to corresponding demultiplexers, that is, a demultiplexer 304 to a demultiplexer 314. The number of branches corresponds to the number Mₖ of sub-channels used for a service to the k^{th} terminal, and the Mₖ is determined as one integer of 1 to 16. Further, the k is defined as a maximum number of terminals capable of simultaneously using the service, having a value between 1 and k. The modulation symbol rows according to each sub-channel, which are output by the demultiplexer 303 according to each branch, have a predetermined frame duration. This frame duration is not related to a frame duration of a modulation symbol row input to the demultiplexer 303.

In order to transmit the modulation symbol rows according to each sub-channel, which are output from the demultiplexer 303, through sub-channels different from each other, a maximum of Mₖ sub-channel transmitters are required. Accordingly, FIG. 3 shows the sub-channel transmitters according to the Mₖ. Since the sub-channel transmitters differ only in input modulation symbol rows and perform the same operation, one sub-channel transmitter will be representatively described below. Meanwhile, one or more of the sub-channels may be assigned to a traffic channel of each terminal. Accordingly, one or more of the sub-channel transmitters may be used for traffic channel transmission in each terminal.

The modulation symbol rows according to each sub-channel, which are output from the demultiplexer 303, are input to Mₖ demultiplexers, that is, corresponding demultiplexers of the demultiplexer 304 to the demultiplexer 314. For instance, a modulation symbol row corresponding to the first sub-channel from among the modulation symbol rows according to each sub-channel, which are output from the demultiplexer 303, is input to the demultiplexer 304. The demultiplexer 304 demultiplexes the modulation symbol row corresponding to the first sub-channel and outputs a plurality of modulation symbol rows according to each sub-carrier. The number of modulation symbol rows according to each sub-carrier corresponds to the number ‘m’ of sub-carriers contained in one sub-channel. The modulation symbol rows according to each sub-carrier, which are output according to each sub-carrier, have a frame duration increase of m times, in comparison with the modulation symbol rows according to each sub-channel. The modulation-symbol rows according to each sub-carrier output from the demultiplexer 304 are input to a channel divider 305. The channel divider 305 band-spreads and outputs the modulation symbol rows according to each sub-carrier by means of an orthogonal sequence having a length of m. The modulation symbol rows according to each sub-carrier are band-spread by orthogonal sequences different from each other. Then, output sequences in a unit of a chip, which are band-spread according to each sub-carrier by the channel divider 305, are input to an adder 306. The adder 306 adds the output sequences with each other in a unit of a chip, which are provided according to each sub-carrier, and thus outputs one sequence. The output sequence from the adder 306 is input to a scrambler 307. The scrambler 307 scrambles the output sequence by means of a scrambling code generated by a scrambling sequence generator 313, and outputs the scrambled sequence to a mapper 308. The mapper 308 inputs a signal output from the scrambler 307, maps the input signal to sub-carriers constituting the first sub-channel assigned to the mapper 308, and outputs the sub-carriers. A frequency hopping function, which dynamically changes sub-carriers constituting the sub-channel according to a fading characteristic of a wireless transmission line, may also be performed by the mapper 308.

Sub-channel transmitters corresponding to the other sub-channels excepting the first sub-channel can output sub-channels to corresponding sub-channels by an operation the same as that of the aforementioned sub-channel transmitter.

A pilot channel transmitter will now be described, which transmits a pilot signal through the pilot channel.

First, the pilot signal is input to a pilot tone position determiner 321. The pilot signal is an unmodulated signal. The pilot tone position determiner 321 determines the position of a sub-carrier into which a pilot tone is inserted. Accordingly, the pilot tone is inserted into the determined position of the sub-carrier later.

As described above, in an OFDM communication system, a transmitter, that is a base station, transmits a pilot sub-carrier, which is pilot channel signals, to a receiver, that is a terminal. Transmitting the pilot channel signals is for synchronization acquisition, channel estimation, and base station differentiation. The pilot channel signals operate as a kind of training sequence and enables channel estimation to be performed between the transmitter and the receiver. Further, the terminal may differentiate a base station to which the terminal itself belongs by means of the pilot channel signals. A position at which the pilot channel signals are transmitted has been predetermined between the transmitter and the receiver. As a result, the pilot channel signals operate as a kind of reference signal.

A process, through which the terminal differentiates the base station to which the terminal itself belongs by means of the pilot channel signals, will be described.

First, the base station transmits the pilot channel signals with a relatively greater transmission power than that for the data channel signals, which enables the pilot channel signals to reach even a cell boundary. The base station allows the pilot channel signals to have a specific pattern, that is a pilot pattern. Here, the reason for the high power transmission of the pilot channel signals even with a specific pilot pattern, which enables the pilot channel signals to reach the cell boundary, is as follows. When the terminal enters a cell, the terminal does not have any information on a base station to which the terminal itself currently belongs. Accordingly, in order to detect the base station to which the terminal itself belongs, the terminal must use the pilot channel signals. For this reason, the base station transmits the pilot channel signals with relatively high transmission power and at a specific pilot pattern, so that the terminal can detect the base station to which the terminal itself belongs.

Further, the pilot pattern is a pattern generated by the pilot channel signals transmitted from the base station. That is, the pilot pattern is generated by a slope of the pilot channel signals and a start point at which the pilot channel signals are transmitted. Accordingly, in the OFDM communication system, in order to allow base stations constituting the OFDM communication system to be differentiated from each other, the base stations must be designed to have pilot patterns different from each other. Consequently, the terminal differentiates the base station to which the terminal itself belongs by means of the pilot pattern. The traffic channel and the pilot channel are transmitted through a frequency division multiplexing (FDM) method.

Hereinafter, a synchronization channel transmitter will be described, which transmits information data through a synchronization channel.

First, the information data is input to a channel encoder 331. The channel encoder 331 encodes the information data of the synchronization channel by a predetermined encoding method, and outputs the encoded information data to a modulator 332. The modulator 332 modulates the encoded information data output from the channel encoder 331 by a predetermined modulation method, and outputs the modulated data as a synchronization channel signal.

Hereinafter, a shared control channel transmitter will be described, which transmits control information through a shared control channel.

First, the control information is input to a channel encoder 341. The channel encoder 341 encodes the control information of the shared control channel by a predetermined encoding method, and outputs the encoded control information to a modulator 342. The modulator 342 modulates the encoded control information output from the channel encoder 341 by a predetermined modulation method, and outputs the modulated information as a shared control channel signal.

Hereinafter, a preamble channel transmitter will be described, which transmits a preamble sequence through a preamble channel.

First, the preamble sequence is input to a pattern generator 351 for synchronization acquisition. The pattern generator 351 for synchronization acquisition causes the preamble sequence to have a predetermined pattern so that a terminal can acquire frame synchronization by means of the preamble sequence, and outputs the preamble sequence as a preamble channel signal. The predetermined pattern represents a repetition pattern of the preamble sequence. That is, the preamble sequence includes a short preamble sequence and a long preamble sequence, and the short preamble sequence or the long preamble sequence may be used repeatedly according to the conditions of a system. The pattern generator 351 for synchronization acquisition determines such a repetition pattern.

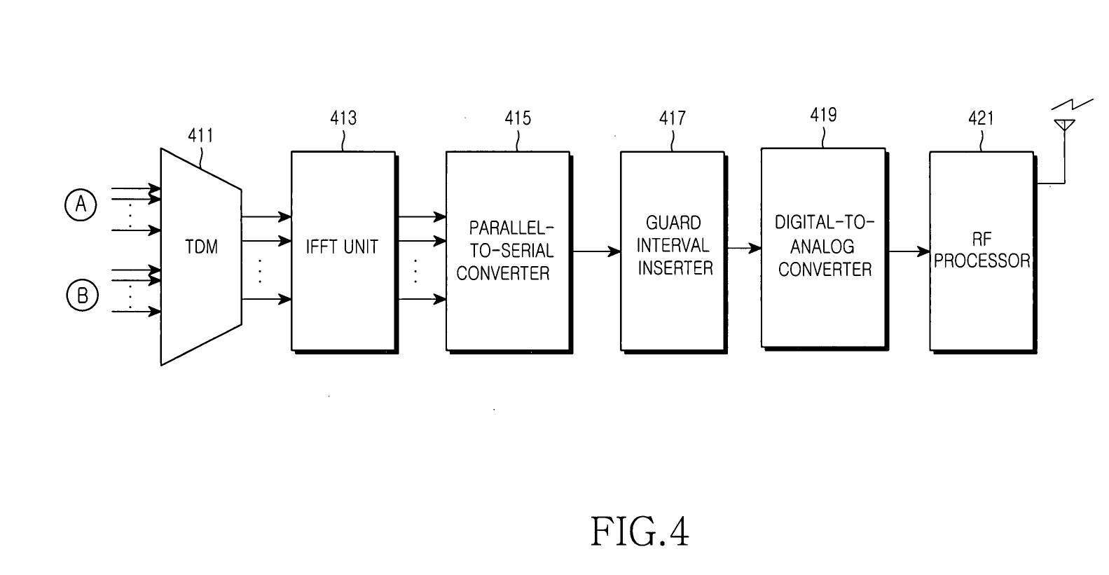

Hereinafter, a structure of a transmitter in the FH-OFCDMA communication system will be described with reference to FIG. 4.

FIG. 4 is a block diagram showing the structure of the transmitter in the FH-OFCDMA communication system for performing functions according to an embodiment of the present invention, and it shows a generation structure of the forward FH-OFCDMA channel according to an embodiment of the present invention.

Before describing the structure of the transmitter, it must be noted that the structure of the transmitter shown in FIG. 4 is the structure of the transmitter performing an operation after the operation performed by the channel transmitter described in FIG. 3. That is, an input terminal A shown in FIG. 4 is connected to an output terminal A shown in FIG. 3, so that the transmitter according to the present invention can be achieved. Accordingly, in FIG. 4, output signals from the channel transmitter described in FIG. 3 are input through the input terminal A. The output signals from FIG. 3 include traffic channel data output according to each sub-channel, pilot channel data, synchronization channel data, and shared control channel data. Further, an input terminal B shown in FIG. 4 is connected to an output terminal B shown in FIG. 3, so that the transmitter according to the present invention can be achieved. Accordingly, an output signal from the channel transmitter described in FIG. 3 is input through the input terminal B in FIG. 4. The output signal of FIG. 3 includes preamble channel data.

Referring to FIG. 4, as described in FIG. 3, the output signals from the channel transmitter are input to a time division multiplexer (TDM) 411 through the input terminals A and B. The time division multiplexer 411 time-division-multiplexes the traffic channel signal, the pilot channel signal, the synchronization channel signal, and the preamble channel signal, and outputs the multiplexed signals to an inverse fast fourier transform (hereinafter, referred to as an IFFT) unit 413.

Hereinafter, a time division multiplexing process by the time division multiplexer 411 will be described in detail with reference to FIG. 1. As described in FIG. 1, one frame cell on a time axis includes 16 time-frequency cells. The time division multiplexer 411 selects and outputs the preamble channel in an interval of the first time-frequency cell from among the 16 time-frequency cells, and selects and outputs the output signals in intervals of the other 15 time-frequency cells.

The IFFT unit 413 inputs the signals output from the time division multiplexer 411, performs an IFFT for the signals, and outputs the signals to a parallel-to-serial-converter 415. The IFFT unit 413 performs an IFFT for the signals, thereby converting a signal in a frequency domain to a signal in a time domain and output the signal in the time domain. The parallel-to-serial-converter 415 inputs the signal output from the IFFT unit 413, converts the input signal to a serial signal, and outputs the serial signal to a guard interval inserter 417. The guard interval inserter 417 inputs the signal output from the parallel-to-serial-converter 415, inserts a guard interval into the input signal, and outputs the signal to a digital-to-analog converter 419. The guard interval is inserted for eliminating interference between an OFMD symbol transmitted at a previous OFMD symbol time and a current OFMD symbol to be transmitted at a current OFMD symbol time when the OFMD communication system transmits the OFMD symbols. Further, the guard interval has been proposed to contain null data of a predetermined interval. However, during the transmission of the null data contained in the guard interval, when a receiver erroneously estimates a start point of an OFMD symbol, interference may occur between sub-carriers, so that the probability of errors for a received OFMD symbol may become greater. Accordingly, a cyclic prefix method or a cyclic postfix method may be used. In the cyclic prefix method, predetermined last bits of an OFMD symbol on a time domain are copied and inserted into an effective OFMD symbol. In the cyclic postfix method, predetermined initial bits of an OFMD symbol on a time domain are copied and inserted into an effective OFMD symbol.

The digital-to-analog converter 419 inputs the signal output from the guard interval inserter 417, converts the signal into an analog signal, and outputs the analog signal to a radio frequency (RF) processor 421. The RF processor 421 includes a filter and a front end unit, etc. The RF processor 421 converts the signal output from the digital-to-analog converter 419 into an RF signal capable of being transmitted over the air, and the send the RF signal through an antenna into the air.

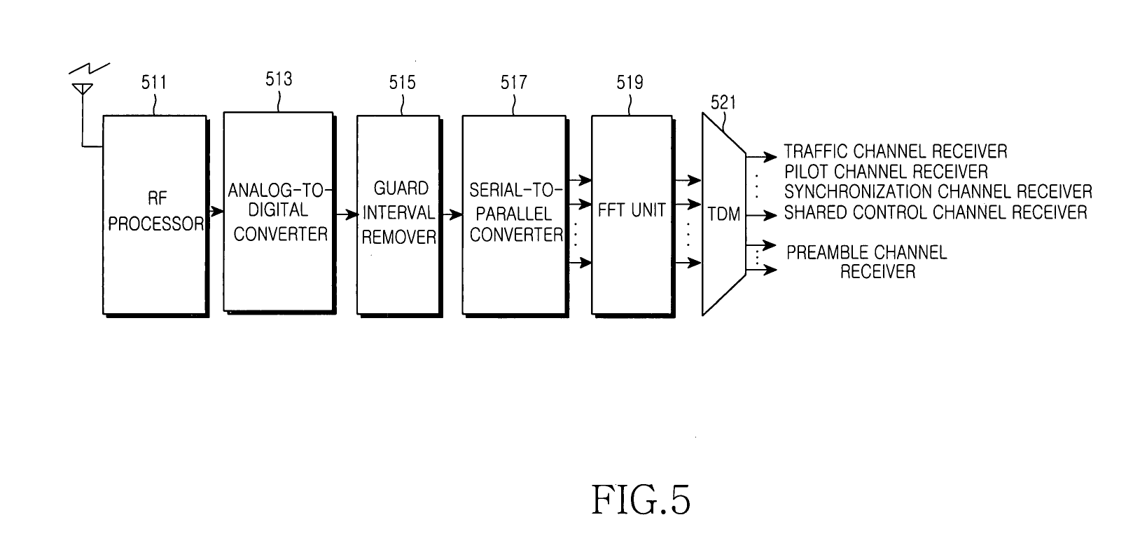

Hereinafter, a structure of a receiver in the FH-OFCDMA communication system will be described with reference to FIG. 5. FIG. 5 is a block diagram showing the structure of the receiver in the FH-OFCDMA communication system for performing functions according to an embodiment of the present invention.

Firstly, a signal transmitted from the transmitter in the FH-OFCDMA communication system experiences actual radio channel environments such as multi-path channels and becomes a signal containing noise. Then, the signal containing noise is received through an antenna of the receiver in the FH-OFCDMA communication system. The signal received through the antenna is input to an RF processor 511. The RF processor 511 down-converts the signal received through the antenna into an intermediate frequency (IF) band and outputs the down-converted signal to a analog-to-digital converter 513. The digital-to-analog converter 513 converts the analog signal output from the RF processor 511 into a digital signal and outputs the digital signal to a guard interval remover 515.

The guard interval remover 515 inputs the signal output from the analog-to-digital converter 513, removes the guard interval signal, and outputs the signal, from which the guard interval has been removed, to a serial-to-parallel converter 517. The serial-to-parallel converter 517 inputs the serial signal output from the guard interval remover 515, converts the serial signal into a parallel signal, and outputs the parallel signal to a fast Fourier transform (FFT) unit 519. The FFT unit 519 performs an N-point FFT for the signal output from the serial-to-parallel converter 517 and outputs the signal to a TDM 521. The TDM 521 inputs the signal output from the FFT unit 519 and time-division-multiplexes the input signal. Then, the TDM 521 outputs a traffic channel signal, a pilot channel signal, a synchronization channel signal, a shared control channel signal, and a preamble channel signal to a traffic channel receiver, a pilot channel receiver, a synchronization channel receiver, a shared control channel receiver, and a preamble channel receiver, respectively. The traffic channel receiver, the pilot channel receiver, the synchronization channel receiver, the shared control channel receiver, and the preamble channel receiver perform a channel receiving operation through an operation inverse to the channel transmitting operation performed by the traffic channel transmitter, the pilot channel transmitter, the synchronization channel transmitter, the shared control channel transmitter, and the preamble channel transmitter. Further, it must be noted that the channel receivers have a structure for performing the operation inverse to the channel transmitting operation performed by the channel transmitters. Since the channel receivers operate within only one terminal, they do not have to consider a plurality of terminals like the channel transmitters of the transmitter. Accordingly, the channel receivers operate considering only a channelization code and a scrambling code corresponding to the aforementioned one terminal.

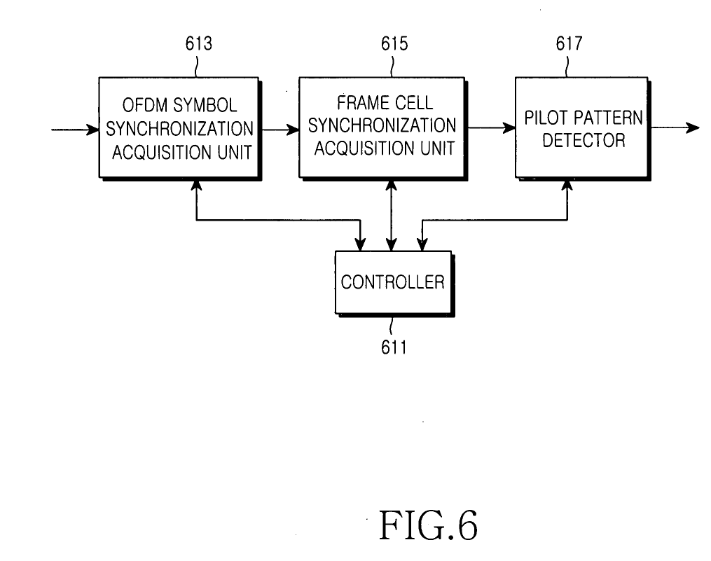

Hereinafter, a structure of a cell search apparatus in the FH-OFCDMA communication system will be described with reference to FIG. 6.

FIG. 6 is a block diagram showing the internal structure of the cell search apparatus in the FH-OFCDMA communication system for performing functions according to an embodiment of the present invention.

Before describing the internal structure of the cell search apparatus, the reason for the performance of a cell search by the FH-OFCDMA communication system is as follows.

First, when a terminal is powered on, the terminal acquires a predetermined base station and attempts to process a call through an access channel of a reverse link. However, the terminal cannot recognize a base station to which the terminal itself belongs when the terminal is powered on. Accordingly, the terminal must search for the base station, to which the terminal itself belongs, that is, a cell in order to perform communication. Hereinafter, a cell search process will be described with reference to FIG. 6.

First, a controller 611 controls a general operation of the cell search apparatus, and an OFDM symbol synchronization acquisition unit 613 acquires an OFDM symbol synchronization by means of the guard interval signal of a received OFDM symbol. As described above, the guard interval is inserted for eliminating interference between an OFMD symbol transmitted at a previous OFMD symbol time and a current OFMD symbol to be transmitted at a current OFMD symbol time when the OFMD communication system transmits the OFMD symbols. Further, the guard interval is used through a cyclic prefix method or a cyclic postfix method. In the cyclic prefix method, predetermined last bits of an OFMD symbol on a time domain are copied and inserted into an effective OFMD symbol. In the cyclic postfix method, predetermined initial bits of an OFMD symbol on a time domain are copied and inserted into an effective OFMD symbol. In the present invention, for convenience of description, it is assumed that the guard interval is inserted according to the cyclic prefix method. When the OFDM symbol synchronization is acquired, the OFDM symbol synchronization acquisition unit 613 correlates the guard interval with the predetermined last bits of the received OFMD symbol, and detects a timing at which a correlation value obtained by the correlation is greater than a predetermined threshold value and has a peak value. As a result, the timing, which is greater than the threshold value and has the peak value, becomes an OFDM symbol timing of a base station to which the terminal itself belongs, that is, an OFDM symbol boundary. The process of detecting the OFDM symbol timing becomes a process of acquiring the OFDM symbol synchronization. Also, the OFDM symbol synchronization acquisition makes it possible to find an FFT start point and perform an FFT.

When recognizing that the OFDM symbol synchronization acquisition unit 613 has detected the OFDM symbol timing, that is the OFDM symbol synchronization acquisition unit 613 has acquired the OFDM symbol synchronization, the controller 611 is synchronized with the detected OFDM symbol timing and controls a frame cell synchronization acquisition unit 615 to acquire a frame cell synchronization. The frame cell synchronization acquisition unit 615 searches for a start point of the frame cell, that is, a frame cell boundary by means of a preamble channel signal, because a start point of a pilot pattern for the differentiation of the base station is set on the basis of the start point of the frame cell and is repeated or changed according to the frame cell. When there exists preamble channels between continued pilot channels, there exists a probability that the pilot pattern, that is the slope between pilot channels, may be erroneously estimated. Accordingly, the start point of the frame cell must be searched. As described above, since the same preamble sequences are repeated and transmitted several times, the repeated sequences are correlated with each other and thus a correlation value is obtained. Accordingly, a timing, at which the correlation value is greater than a predetermined threshold value and has a peak value, becomes a start point of a frame cell of a base station to which the terminal itself belongs. Hereinafter, a process of detecting the start point of the frame cell will be described in detail.

First, it is assumed that a terminal receives signals from a first base station BS 1 and a second base station BS 2. It is impossible for the terminal to determine if the signals received from the first base station and the second base station are data or preamble signals. However, since the terminal can determine if the received signals are repeated, the terminal correlates repeated sequences with each other. Accordingly, when a correlation value obtained by the correlation is greater than a threshold value set in advance and has a peak value, the terminal determines the correlation value as the start point of the frame cell.

Next, when recognizing that the start point of the frame cell has been acquired, that is the frame cell synchronization acquisition unit 615 has acquired a frame cell synchronization, the controller 611 is synchronized with the detected start point of the frame cell and controls a pilot pattern detector 617 to detect a pilot pattern. The pilot pattern can be detected even when the frame cell synchronization has not been acquired and only the OFDM symbol synchronization has been acquired, and this will be described in detail. First, the reason detecting the start point of the frame cell by the use of the preamble channel signal is that an exact pilot pattern sometimes cannot be detected due to the preamble channel signal when detecting a pilot pattern. However, when such a case does not occur or an exact pilot pattern can be detected by only two pilot signals, it is not necessary to detect the start point of the frame cell. Accordingly, an input/output to the frame cell synchronization acquisition unit 615 may be bypassed. The pilot pattern detector 617 detects the position of a pilot channel signal by an asynchronous energy detection process and detects a pilot pattern by means of the detected position of the pilot channel signal. Hereinafter, an operation of the pilot pattern detector 617 will be described in detail.

First, when a received signal is subjected to an FFT by means of the OFDM symbol timing acquired by the OFDM symbol synchronization acquisition unit 613, the received signal is converted to a signal in a frequency domain. Then, the pilot pattern detector 617 detects the position of a received pilot signal from the received signal in the frequency domain through the asynchronous energy detection. As described above, since pilot signals are transmitted with a relatively greater transmission power than that for other channel signals, which enables the pilot channel signals to reach even a cell boundary, the pilot signals are detected at a peak value even though the asynchronous energy detection is performed. After detecting the position of the pilot signal as described above, the pilot pattern detector 617 detects the pilot pattern by means of the detected pilot signals. The controller 611 compares the pilot pattern detected by the pilot pattern detector 617 with table-type pilot patterns already stored in an internal memory of the controller 611. As a result of the comparison, when there exists a pilot pattern coinciding with the detected pilot pattern, the controller 611 determines that a base station corresponding to the detected pilot pattern is a base station to which the terminal itself belongs. The comparison between the detected pilot pattern and the pilot patterns stored in advance is performed through a correlation operation. Further, even though there exists a pilot pattern coinciding with the detected pilot pattern, when a correlation value obtained by the correlation operation is less than a predetermined threshold value, the controller 611 considers the detection of the pilot pattern as an inexact detection of a pilot pattern and removes an error.

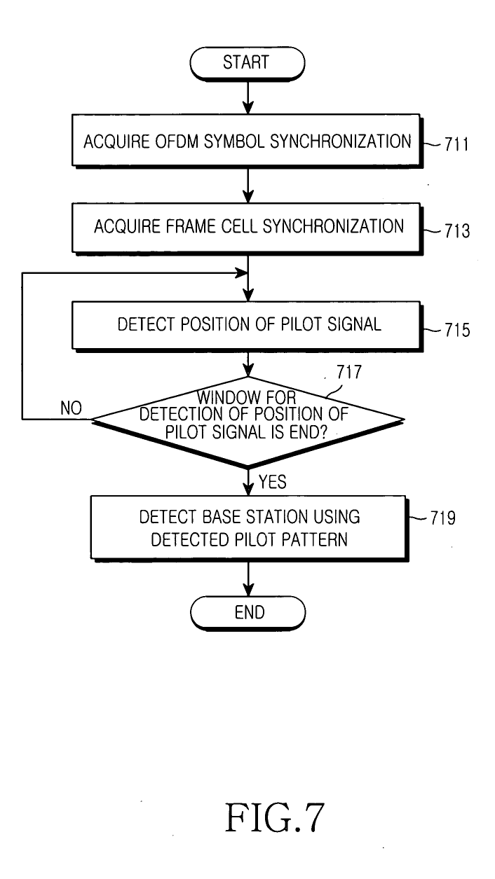

Hereinafter, a cell search process in the FH-OFCDMA communication system will be described with reference to FIG. 7.

FIG. 7 is a flowchart of the cell search process in the FH-OFCDMA communication system according to an embodiment of the present invention.

Referring to FIG. 7, in step 711, the controller 611 controls the OFDM symbol synchronization acquisition unit 613 to obtain an OFDM symbol synchronization by means of a guard interval signal of a received OFDM symbol. Then, step 713 is performed. Herein, the OFDM symbol synchronization acquisition unit 613 correlates the guard interval and the predetermined last bits of a received OFMD symbol, detects a timing at which a correlation value obtained by the correlation is greater than a threshold value set in advance and has a peak value, and thus acquires the OFDM symbol synchronization. Further, the reason for the correlation between the guard interval and the predetermined last bits of the received OFMD symbol is that it is assumed to employ a cyclic prefix method.

In step 713, the controller 611 controls the frame cell synchronization acquisition unit 615 to acquire a frame cell synchronization according to the OFDM symbol synchronization acquired by the OFDM symbol synchronization acquisition unit 613. The frame cell synchronization acquisition unit 615 correlates a received preamble channel signal with an already known preamble sequence, detects a timing at which a correlation value obtained by the correlation is greater than a predetermined threshold value and has a peak value, and determines the correlation value to be a start point of a frame cell of a base station to which the terminal belongs. Then, step 715 is performed. Consequently, the start point of the frame cell becomes a boundary of the frame cell.

In step 715, the controller 611 is synchronized with the start point of the frame cell detected by the frame cell synchronization acquisition unit 615 and controls the pilot pattern detector 617 to detect a pilot pattern. Then, step 717 is performed. The pilot pattern detector 617 is synchronized with the start point of the frame cell detected by the frame cell synchronization acquisition unit 615, performs an FFT according to each received OFDM symbol interval, and detects the position of a pilot signal by an asynchronous energy detection process.

In step 717, the controller 611 determines if a window interval search, which is to be searched by the pilot pattern detector 617 for the position detection of the pilot signal, has been completed or not. From the result of the determination, when the window interval search has not been completed, step 715 is performed. That is, the controller 611 controls the pilot pattern detector 617 to continuously perform the position detection of the pilot signal. In contrast, when the window interval search has been completed, step 719 is performed. That is, the controller 611 compares a pilot pattern according to positions of the detected pilot signals with pilot patterns stored in advance. From the result of the comparison, when there exists a pilot pattern coinciding with the detected pilot pattern, the controller 611 determines that a base station corresponding to the detected pilot pattern is a base station to which the terminal itself belongs, and ends the procedure. Herein, the comparison between the detected pilot pattern and the pilot patterns stored in advance: is performed through a correlation operation. Further, even though there exist a pilot pattern coinciding with the detected pilot pattern, when a correlation value obtained by the correlation operation is less than a predetermined threshold value, the controller 611 considers the detection of the pilot pattern as an inexact detection of a pilot pattern and removes an error.

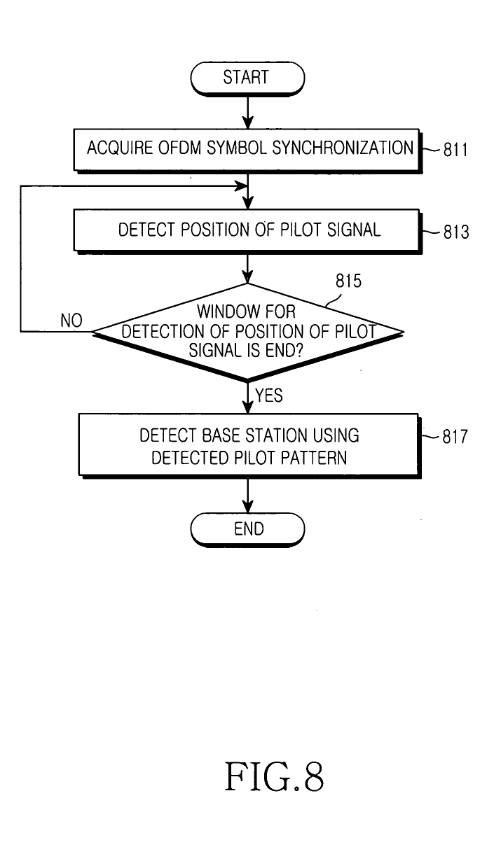

Hereinafter, another cell search process in the FH-OFCDMA communication system will be described with reference to FIG. 8.

FIG. 8 is a flowchart of the cell search process in the FH-OFCDMA communication system according to another embodiment of the present invention.

Before describing the cell search process, since step 811 in FIG. 8 includes the same operation as that of step 711 in FIG. 7 and step 813 to step 817 in FIG. 8 include the same operations as those of step 715 to step 719 in FIG. 7, a description of the steps will be omitted. The reason why a process corresponding to step 713 in FIG. 7 for detecting a start point of a frame cell is not included in FIG. 8 is as follows.

The reason for detecting the start point of the frame cell by means of the preamble channel signal in step 713 is that an exact pilot pattern sometimes cannot be detected due to the preamble channel signal when detecting a pilot pattern. However, when such a case does not occur or an exact pilot pattern can be detected by only two pilot signals, it is not necessary to perform an operation the same as the operation of step 713. Accordingly, FIG. 8 does not include the detection operation of the start point of the frame cell of step 713.

According to the present invention a described above, a mobile communication system employing an FH-OFCDMA method performs a multi-step cell search by means of an OFDM symbol timing, a start point of a frame cell, and a pilot pattern, thereby causing an effective and quick cell search to be performed. Further, according to the present invention, the multi-step cell search, which uses the OFDM symbol timing, the start point of the frame cell, and the pilot pattern, minimizes the operation required in the cell search and enables hardware to be simply constructed.

While the invention has been shown and described with reference to certain preferred embodiments thereof, it will be understood by those skilled in the art that various changes in form and details may be made therein without departing from the spirit and scope of the invention as defined by the appended claims.

1. A method for searching for a cell by a terminal in a mobile communication system employing a multiple access scheme, the method comprising the steps of:
a) detecting a symbol boundary of an input reception signal;
b) detecting a frame cell boundary after synchronizing with the detected symbol boundary;
c) detecting a reference signal for each symbol interval in a preset search interval; and
d) detecting a pattern of the reference signals and determining a base station to which the terminal belongs.

2. The method as claimed in claim 1, wherein step a) further includes the steps of correlating each symbol of the reception signal with a guard interval of each symbol and determining a timing having a peak value as the symbol boundary.

3. The method as claimed in claim 2, wherein the guard interval includes a predetermined number of one of last bits and initial bits of the symbol.

4. The method as claimed in claim 1, wherein step b) further includes the steps of correlating the reception symbol of each symbol interval of the reception signal with a preset preamble signal and determining a timing having a peak value as the frame cell boundary.

5. The method as claimed in claim 1, wherein step c) further includes the steps of performing an fast Fourier transform for each symbol interval and determining signals having a peak value as the reference signals through asynchronous energy detection.

6. The method as claimed in claim 1, wherein step d) further includes the steps of comparing the detected pattern with a pattern assigned to each base station, and determining a base station, having a same pattern as that of the detected pattern, as a base station to which the terminal belongs when the base station having the same pattern as that of the detected pattern exists as a result of a comparison.

7. The method as claimed in claim 1, wherein the pattern is a slope of reference signals transmitted in sub-frequency bands.

8. The method as claimed in claim 1, wherein the search interval is a predetermined number of symbol intervals.

9. The method as claimed in claim 1, wherein the reference signal is a pilot signal.

10. A method for searching for a cell by a terminal in a mobile communication system employing a multiple access scheme, the method comprising the steps of:
a) detecting a symbol boundary of an input reception signal;
b) detecting a reference signal for each symbol interval in a preset search interval after synchronizing with the symbol boundary; and
c) detecting a pattern of the reference signal and determining a base station to which the terminal belongs.

11. The method as claimed in claim 10, wherein step a) further includes the steps of correlating each symbol of the reception signal with a guard interval of each symbol and determining a timing having a peak value as the symbol boundary.

12. The method as claimed in claim 11, wherein the guard interval includes a predetermined number of last bits or initial bits of the symbol.

13. The method as claimed in claim 10, wherein step b) further includes the steps of performing an fast Fourier transform for each symbol interval and determining signals having a peak value as the reference signals through asynchronous energy detection.

14. The method as claimed in claim 10, wherein step c) further includes the steps of comparing the detected pattern with a pattern assigned to each base station, and determining a base station, having a same pattern as that of the detected pattern, as a base station to which the terminal belongs when the base station having the same pattern as that of the detected pattern exists as a result of a comparison.

15. The method as claimed in claim 10, wherein the pattern is a slope of reference signals transmitted in sub-frequency bands.

16. The method as claimed in claim 10, wherein the search interval is a predetermined number of symbol intervals.

17. The method as claimed in claim 10, wherein the reference signal is a pilot signal.

18. An apparatus for searching for a cell in a mobile communication system employing a multiple access scheme, the apparatus comprising:
a symbol synchronization acquisition unit for detecting a symbol boundary of an input reception signal;
a frame cell synchronization acquisition unit for detecting a frame cell boundary after synchronizing with the symbol boundary detected by the symbol synchronization acquisition unit;
a pattern detector for detecting a reference signal for each symbol interval in a preset search interval, and detecting a pattern of the detected reference signals; and
a controller for comparing the pattern detected by the pattern detector with stored patterns and detecting a base station to which the terminal belongs.

19. The apparatus as claimed in claim 18, wherein the symbol synchronization acquisition unit correlates each symbol of the reception signal with a guard interval of each symbol and determines a timing having a peak value as the symbol boundary.

20. The apparatus as claimed in claim 19, wherein the guard interval includes a predetermined number of last bits or initial bits of the symbol.

21. The apparatus as claimed in claim 18, wherein the frame cell synchronization acquisition unit correlates reception symbols according to each symbol interval of the reception signal with a preset preamble signal and determines a timing having a peak value as the frame cell boundary.

22. The apparatus as claimed in claim 18, wherein the pattern detector performs an fast Fourier transform according to each symbol interval and determines signals having a peak value as the reference signals through asynchronous energy detection.

23. The apparatus as claimed in claim 18, wherein the controller compares the detected pattern with patterns assigned to each base station, and determines a base station, having a same pattern as that of the detected pattern, as a base station to which the terminal belongs when the base station having the same pattern that of the detected pattern exists as a result of a comparison.

24. The apparatus as claimed in claim 18, wherein the pattern is a slope of reference signals transmitted in sub-frequency bands.

25. The apparatus as claimed in claim 18, wherein the search interval is a predetermined number of symbol intervals set in advance.

26. The apparatus as claimed in claim 18, wherein the reference signal is a pilot signal.

27. An apparatus for searching for a cell in a mobile communication system employing a multiple access scheme, the apparatus comprising:
a symbol synchronization acquisition unit for detecting a symbol boundary of an input reception signal;
a pattern detector for detecting a reference signal for each symbol interval in a preset search interval after synchronizing with the symbol boundary detected by the symbol synchronization acquisition unit, and detecting a pattern of the detected reference signals; and
a controller for comparing the pattern detected by the pattern detector with patterns stored in advance and detecting a base station to which the terminal belongs.

28. The apparatus as claimed in claim 27, wherein the symbol synchronization acquisition unit correlates each symbol of the reception signal with a guard interval of each symbol and determines a timing having a peak value as the symbol boundary.

29. The apparatus as claimed in claim 28, wherein the guard interval includes a predetermined number of last bits or initial bits of the symbol.

30. The apparatus as claimed in claim 27, wherein the pattern detector performs an fast Fourier transform according to each symbol interval and determines signals having a peak value as the reference signals through asynchronous energy detection.

31. The apparatus as claimed in claim 27, wherein the controller compares the detected pattern with patterns assigned to each base station, and determines a base station, having a same pattern as that of the detected pattern, as a base station to which the terminal belongs when the base station having the same pattern that of the detected pattern exists as a result of a comparison.

32. The apparatus as claimed in claim 27, wherein the pattern is a slope of reference signals transmitted in sub-frequency bands.

33. The apparatus as claimed in claim 27, wherein the search interval is a predetermined number of symbol intervals set in advance.

34. The apparatus as claimed in claim 27, wherein the reference signal is a pilot signal.

35. A method for searching for a cell by a terminal in a mobile communication system including at least a frame cell which is occupied by a plurality of subchannels having time domain and frequency domain, the method comprising the steps of:
a) detecting a symbol boundary of an input reception signal;
b) detecting the frame cell boundary after synchronizing with the detected symbol boundary;
c) detecting a reference signal for each symbol interval in a preset search interval; and
d) detecting a pattern of the reference signals and determining a base station to which the terminal belongs.
